(19) United States
(12) Patent Application Publication
(10) Pub. No.: US 2005/0273649 A1
(43) Pub. Date: Dec. 8, 2005

(54) Apparatus for high-speed streaming data transmission using PMEM controller and method thereof

(75) Inventors: Byung Kwon Jung, Taejon (KR); Seong Woon Kim, Taejon (KR); Myung Joon Kim, Taejon (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/132,214

(22) Filed: May 19, 2005

(30) Foreign Application Priority Data
May 31, 2004 (KR) 2004-38918

(51) Int. Cl. G06F 11/00

(52) U.S. Cl. 714/5

(57) ABSTRACT

Disclosed are an apparatus for a high-speed streaming data transmission using a PMEM controller and a method thereof. The PMEM controller (i.e., an I/O processor) transmits data stored in a storage device to a network through a process for a PMEM to local copy of the data between a large-capacity PM (Peripheral Memory) and a main memory or for a PMEM to PMEM copy of the data in the PM. According to this process, the data transmission speed can be improved. Also, by reducing the memory copy of disc streaming data, the interference with the main processor can be minimized, and thus high-quality streaming data can be supported.

### BACKGROUND OF THE INVENTION

1. Field of the Invention

The present invention relates to an apparatus for a high-speed streaming data transmission using a PMEM controller and a method thereof, and more particularly, to an apparatus for a high-speed streaming data transmission using a PMEM controller and a method thereof that can solve the load of a main processor and the bottleneck of a common bus in transmitting the data through the Internet and thus can provide efficient high-quality streaming data by reading the streaming data from a disc to a PCI (Peripheral Component Interface) memory (hereinafter referred to as a “PM (Peripheral Memory)”) using an NS (Network Storage) card that is separately provided with the PMEM (Processor Memory) controller (hereinafter referred to as an “I/O processor”), an SCSI (Small Component Small Interface) controller, the PM and a gigabyte NIC (Network Interface Controller) on a PCI bus, and by providing through the NIC the data stored in the PM by a zero-copy method (i.e., by directly providing information received from a network to a user or the data such contents stored in the disc through the network without a memory-copy).

2. Background of the Related Art

In the last several years, high-quality moving picture services and audio stream data have been provided through the Internet as Internet users are abruptly increased.

However, the transmission of multimedia data is subject to restriction due to the limits of network bandwidths and performance of Internet servers. Additionally, although the performances of microprocessors and memories have continuously been improved, the constructions and software of general computers are still inappropriate for the processing of video/audio data.

Additionally, in the conventional Internet server, the video/audio data, which is the streaming data being mainly transferred through the Internet and which has a large size in comparison to the general data, is processed by a main processor, and this causes the performance of the server to deteriorate during the processing of the streaming data.

Additionally, as the transmission bandwidth of the Internet becomes wider, a higher performance of the computer server that should transmit the streaming data is required.

Consequently, although the amount of data to be processed by the multimedia server is abruptly increased, the operating system of the server cannot keep up with the developing speed of hardware that is rapidly developing.

In order to properly process the network service, there is a growing tendency that a TOE (TCP/IP Offload Engine) having a separate processor function performs the TCP/IP function that has been performed in the existing main processor.

Specifically, as the TOE hardware performs the TCP/IP function instead of the operating system, it can promptly respond to a user's demand through the network, and the server processor dispenses with much work to improve the whole system performance.

As the TOE (TCP/IP Offload Engine) related technology, Alacritech has proposed a method for transmitting data from the PM (Peripheral Memory) to the network in the form of a zero-copy without any copy between memories by directly accessing the PM area through the hardware (Laurence B. Boucher, Stephen E. J. Blightman, Intelligent Network Interfaced Device and System for Accelerated Communication, U.S. Pat. No. 6,427,173 BI, Date of Patent: Jul. 30, 2002.) Additionally, many patents including a Korean Patent Number P2003-0013815 entitled “Hard Disc System”, Date of Patent: Feb. 15, 2003, have been issued for hard disc systems in which a hard disc that is independent of any computer system is connected to a network, and a plurality of computer systems that access the IP network through IP cables can share the hard disc through middleware.

However, the above-described technologies have the drawbacks in that they have no regard for the disc access for transmitting the streaming data although they use the TOE, and the host processor incurs great load in transmitting the streaming data. Additionally, the respective constituent elements should separately be provided and they are suitable only for the place that requires small and medium-sized storage devices.

### SUMMARY OF THE INVENTION

Accordingly, the present invention is directed to an apparatus for a high-speed streaming data transmission using a PMEM controller and a method thereof that substantially obviate one or more problems due to limitations and disadvantages of the related art.

It is an object of the present invention to provide an apparatus for a high-speed streaming data transmission using a PMEM controller and a method thereof whereby an I/O (Input/Output) processor transmits data stored in a storage device to a network through a process for a PMEM to local copy of the data between a large-capacity PM (Peripheral Memory) and a main memory or for a PMEM to PMEM copy of the data in the PM that is performed by a DMA controller in the I/O processor.

The present invention is not used for the copy of all data, but is only to process a large-capacity data block by receiving a command from a main processor.

Additional advantages, objects, and features of the present invention will be set forth in part in the description which follows and in part will become apparent to those having ordinary skill in the art upon examination of the following or may be learned from practice of the present invention. The objectives and other advantages of the present invention may be realized and attained by the structure particularly pointed out in the written description and claims hereof as well as the appended drawings.

In order to achieve the above and other objects, there is provided an apparatus for a high-speed streaming data transmission using a PMEM controller, according to the present invention, which comprises a PCI (Peripheral Component Interface) bus bridge, having a register installed therein for designating an address, for transferring a transferred bus transaction to a local PCI bus if the bus transaction requested by a main controller accesses NSUs (Network Storage Units), an internal local PCI bus, separated from a main PCI bus outside the NSUs, for a date transmission with respective devices inside the NSUs, a disc controller, connected in parallel to a plurality of disc storages connected to the NSUs, for managing data by dividing the data transferred to discs through the main processor or a network into specified data groups and storing the data groups in the discs, a PM (Peripheral Memory), inherently provided inside the NSUs, for buffering a data transmission between the storages and the network, and a PMEM controller for controlling a built-in register for designating a size of the PM, receiving a command of the main controller and making an SCSI (Small Component Small Interface) controller read from the discs and store in the PM the data to be transmitted to the network through a data block copy in the PM or a data block copy between the PM and a main memory, and making an NIC (Network Interface Controller) read the data from the PM and transmit the data through a DMA (Direct Memory Access) method.

In another aspect of the present invention, there is provided a method of a high-speed streaming data transmission using a PMEM controller, which comprises the steps of receiving a command from a main controller and obtaining a virtual address of a corresponding PCI (Peripheral Component Interface) memory area by mapping a specified area of a PMEM onto a user memory are, and then requesting an SCSI (Small Component Small Interface) disc block read to the PMEM area, an SCSI to PMEM copy step of storing the data of the corresponding disc block read by an SCSI controller in the corresponding PMEM area through a DMA (Direct Memory Access) method, sending a command to a DMA part of an NIC (Network Interface Controller) in order to transmit the data stored in the PMEM area to a network, and the DMA part of the NIC transmitting the read data to the network by performing a checksum offloading of the data after confirming works of a PCI bus and a main PCI bus.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic block diagram illustrating an Internet server computer system with a network storage card installed therein to which the present invention is applied;

FIG. 2 is a block diagram illustrating an apparatus for a high-speed streaming data transmission according to the present invention;

FIG. 3 is a flowchart illustrating an SCSI to PMEM DMA transmission method according to the present invention;

FIG. 4 is a flowchart illustrating a PMEM to PMEM copying method according to the present invention;

FIG. 5 is a flowchart illustrating a PMEM to local memory copying method according to the present invention;

FIG. 6 is a flowchart illustrating a PMEM to NIC DMA transmission method according to the present invention; and

FIG. 7 is a flowchart illustrating a local memory to NIC DMA transmission method according to the present invention.

### DETAILED DESCRIPTION OF THE PREFERRED EMBODIMENT

The apparatus and method for producing application software for a streaming service and the system and method for providing a software streaming service with network fault tolerance according to the preferred embodiment of the present invention will now be explained in detail with reference to the accompanying drawings.

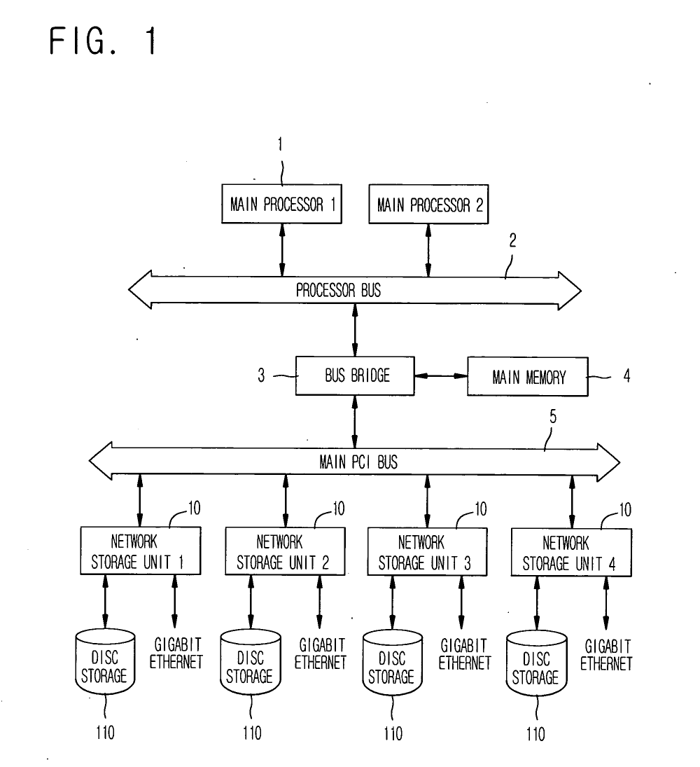

FIG. 1 is a schematic block diagram illustrating an Internet server computer system with a network storage card installed therein to which the present invention is applied.

As illustrated in FIG. 1, the Internet server computer system has a structure in which main processors 1 are connected to a processor bus 2, and to this processor bus 2, a bus bridge 3 for accessing a main memory 4 or for connecting to a main PCI bus 5 is connected.

The bus bridge 3, if a bus transaction for a command performed by the main processors 1 appears on the bus 2, analyzes this and finds which device the bus transaction

Mostly, this process is judged by an address driven in an address bus, and an address are is allocated to each device. After the transaction of the processor bus 2 accesses a memory area, i.e., the main memory 4 and then its peripheral device, the bus bridge serves to shift the bus transaction to the main PCI bus 5.

A plurality of NSUs (Network Storage Units) 10 according to the present invention, the number of which corresponds to the number of connectable devices, is connected to the main PCI bus 5.

Also, the NSUs 10 operate to match the interface of the main PCI bus 5, and are connected to network devices such as disc storages 110 and Ethernet as well.

Accordingly, if the NSUs access the discs according to the request of the main processor 1 being transferred through the bus bridge 3, they read/write data from/in the disc storages, while if they receive the request for network access, they serve to transmit data packets through the network device.

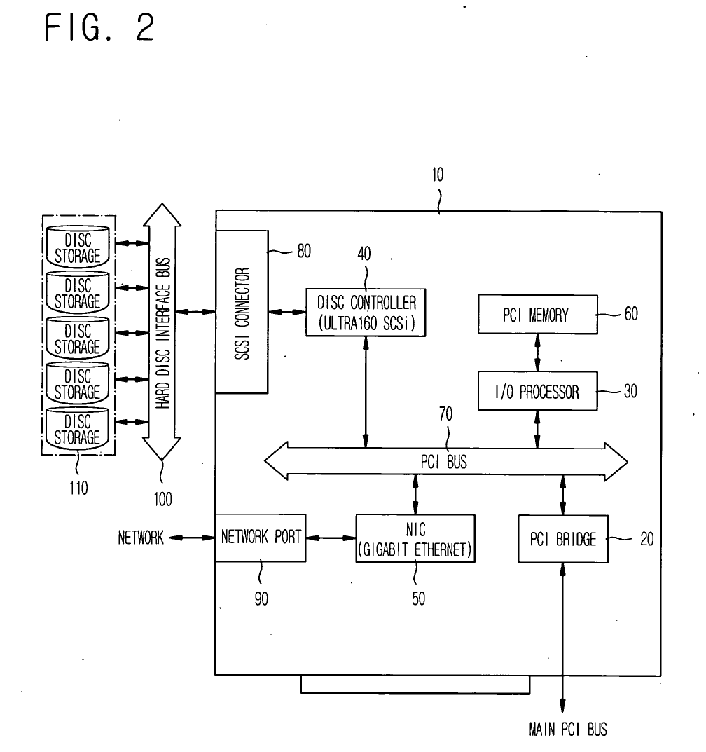

FIG. 2 is a block diagram illustrating the construction of the apparatus for a high-speed streaming data transmission according to the present invention.

As illustrated in FIG. 2, the NSU 10 includes a PCI bus bridge 20 for a smooth transaction between a PCI bus 70 and the NSU 10, a disc controller 40 and discs 110 concerned with storage devices, an I/O processor 30 and a PCI memory 60, separately provided in the NSU 10 in addition to the main processor 1, for a high-speed transmission of stream data, and an NIC 50 concerned with the network.

First, the PCI bridge 20, if the bus transaction requested by the main controller 1 accesses the NSUs 10, transfers this transaction, which has been transferred by the main bus bridge 3 through the main PCI bus 5, to the PCI bus 70 of the NSUs 10.

Accordingly, the PCI bridge 20 has a register for designating an address. The register also stores information about various resources used in the NSUs 10 while the system performs its nitialization work.

The PCI bridge 20 may be used to inform the main processor 1 of the bus transaction proceeding in the NSUs 10. That is, the PCI bridge may be used to transfer the transaction accessing the main memory 4 to the main bus bridge 3 if the transaction is performed or to transfer the transaction being performed by the processor if the transaction accesses the PCI device.

Additionally, the PCI bridge 20 serves to connect the I/O processor (i.e., PMEM controller) 30, NIC 50 and SCSI controller 40 to the main PCI bus 5 of the server platform, and makes it possible to perform the transaction of the PCI bus 70 for a data transmission among the above-mentioned three devices without affecting the main PCI bus 5 of the server platform. The PCI bridge 20 also makes it possible that other PCI devices use the PCI bus 70 of the server platform even while the transaction between the storage 110 and the PM 60 or between the network and the PM 60 is performed, so that the whole performance of the server can be improved.

The separation of the PCI bus 70 as described above provides an effect that the data transmission among the three devices is not affected by the transaction of the PCI bus 70 of the server platform, and this causes the performance of the NS device 10 itself to be improved in comparison to the case that the PCI bus 70 is not separated, i.e., that both the storage 110 and the network device occupy the PCI slot of the platform.

The PCI bus 70 is constructed to be separate from the main PCI bus 5, and thus the bus transaction between the network storages that is proceeding in the NSUs 10 does not actually appear on the main PCI bus 5. This may abruptly decrease the bus traffic of the main PCI bus 5.

The disc controller 40 prevents other bottleneck phenomena from occurring due to the disc accesses by connecting many discs 110 in parallel, and includes a function of striping the discs 110 so as to dividedly store the data in many discs 110.

The disc striping is to divide a large amount of data into many data groups and to dividedly store the data groups in the respective discs if the storage of the large amount of data is requested through the network, and this enables all the discs to be used.

A mostly used disc interface bus is an SCSI protocol 80.

Since the SCSI has a CPU occupancy rate lower than the IDE and the data transmission capability of the SCSI protocol is recently reaching the degree of about 160 MBps or 320 MBps, the disc striping method is used as the method for the maximum use of the data transmission bandwidth.

The PCI memory (i.e., PM) 60 is inherently provided inside the NSUs 10 and serves to buffer the data transmission between the storages and the network. In the case in which the data should be transmitted through the network, the I/O processor 30 stores the data transmitted from the discs 110 in the PCI memory 60 at a high speed of 1.6 GB/s, and the contents of the PCI memory 60 that stores the data are again transmitted to the network through the NIC 50.

The I/O processor 30 controls the PCI memory 60, and has a built-in memory for designating the size of the internal PCI memory 60.

Additionally, the I/O processor 30 has a function of receiving a command of the main processor 1, and making the SCSI controller read from the discs 110 and transmit through a DMA method the data to be transmitted to the network through a data block copy in the PM 60 or a data block copy between the PM 60 and the main memory 4.

The reason why the read/write operation is not directly performed by the main processor 1 but is performed by the I/O processor is that the writing speed of all the processors including the I/O processor 30 is higher than the reading speed thereof.

The NS device 10 has a structure in which the NIC 50 and the SCSI device do not use the main memory 1 of the host, but use the PM 60 provided in the PCI bus 70 that is equal to the corresponding devices in order to improve the data transmission speed. In the I/O processor 30, a DMA controller for accelerating a data block copy between the PM 60 and the main memory 4 or a data block copy in the PM 60 is provided.

This is not used for the copy of all the data, but is used only for the copy of a large-capacity data block under the command from the main processor.

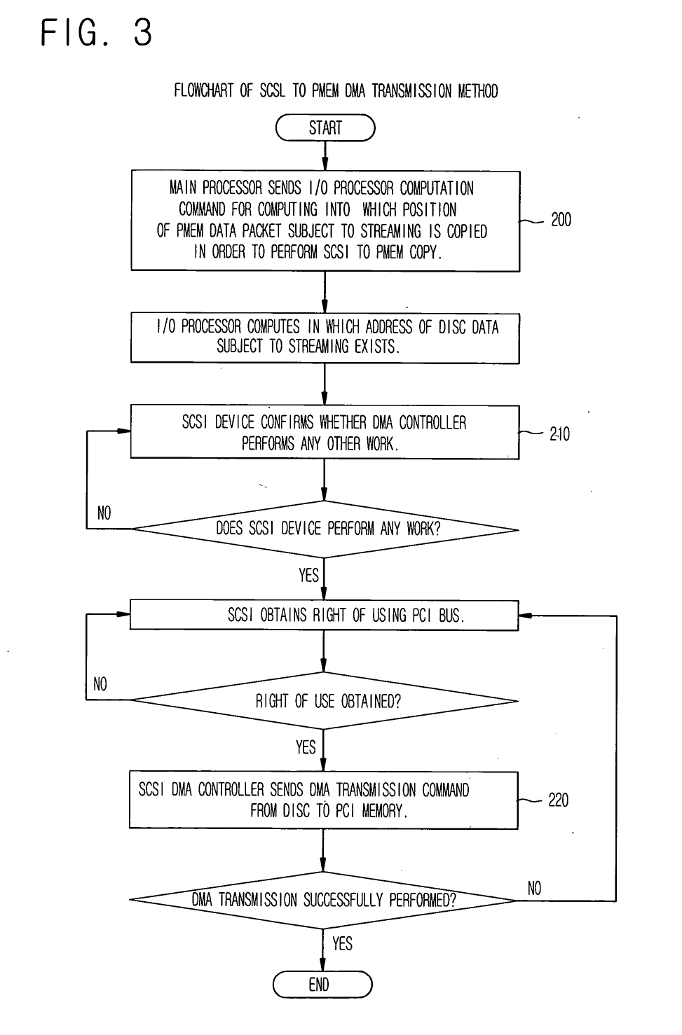

FIG. 3 is a flowchart illustrating an SCSI to PMEM DMA transmission method according to the present invention. In order to perform the SCSI to PMEM copy, the SCSI controller is connected to the SCSI discs, controls the SCSI discs and processes the disc input/output signals.

The I/O processor 30 shows a PCI address area with respect to the PMEM, and processes input/output signals thereof.

In order to transmit the data stored in the SCSI discs to the PMEM, the I/O processor 30 receives a computation command for computing in which position in the PMEM the data packet subject to streaming is copied from the main processor 1 (step S200) and computes in which address of the disc the data subject to streaming exists (step S210) for the SCSI to PMEM copy.

Then, the SCSI device confirms whether the DMA controller performs any other work (step 220). If the DMA controller does not perform any other work, the SCSI device obtains the right of using the PCI bus 70 provided in the NS card 10 (step S230), and the SCSI DMA controller sends a DMA transmission command to the PCI memory (step S240).

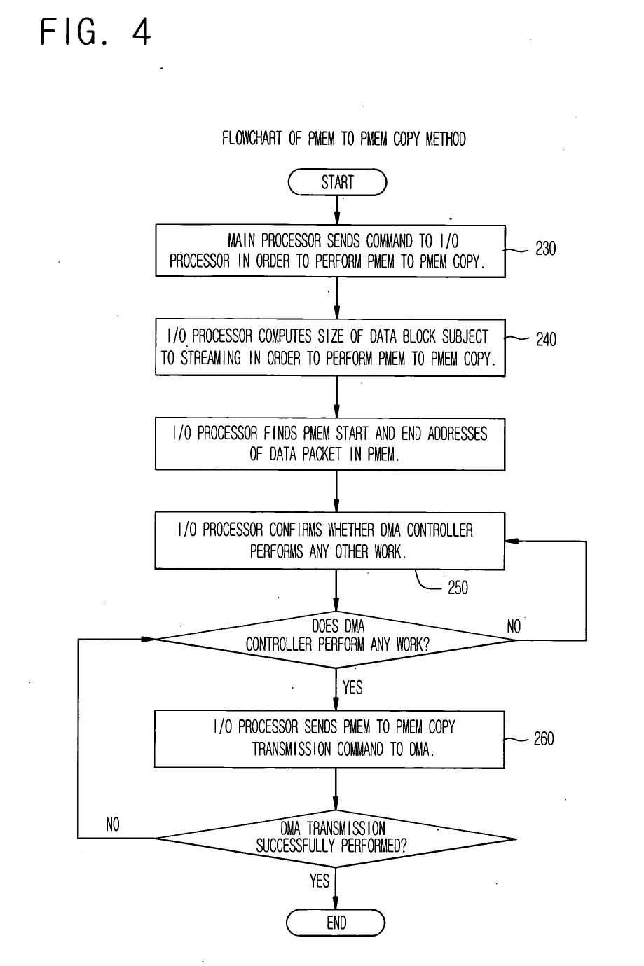

FIG. 4 is a flowchart illustrating a PMEM to PMEM copying method according to the present invention. If the main processor 1 sends a command for performing a PMEM to PMEM copy to the I/O processor 30 (step S300), the I/O processor 30 computes the size of a data block object to streaming (step S310).

The I/O processor 30 finds start and end addresses of the data packet existing in the PMEM (step S320), and confirms whether the DMA controller performs any other work (step S330). If the DMA controller does not perform any other work, the I/O processor sends a PMEM to PMEM copy transmission command to the DMA part (step S340).

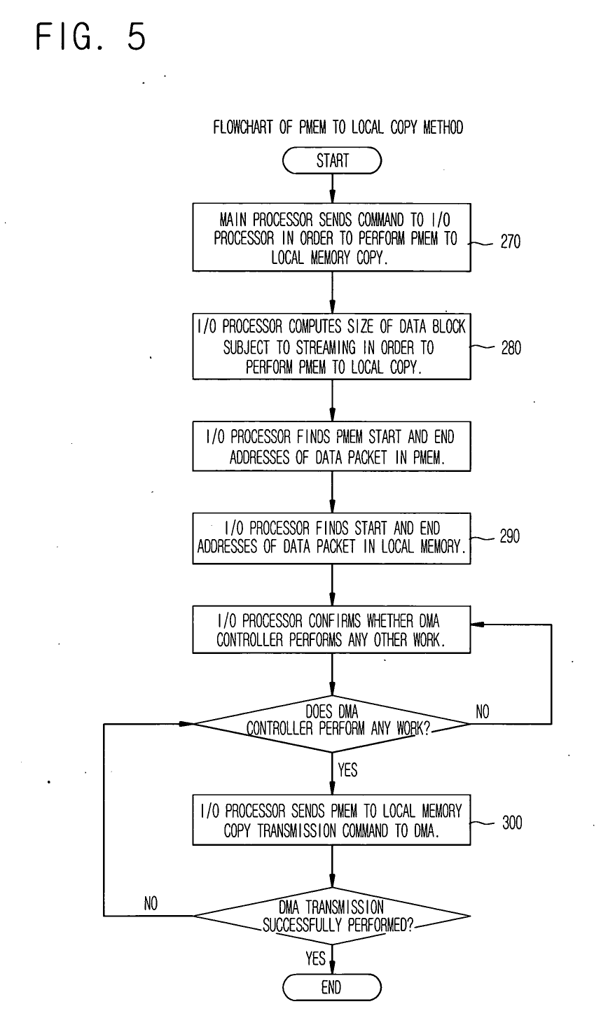

FIG. 5 is a flowchart illustrating a PMEM to local memory copying method according to the present invention.

According to the PMEM to local memory copying method as illustrated in FIG. 5, if the main processor 1 sends a command for performing a PMEM to local memory copy to the I/O processor 30 (step S400), the I/O processor 30 computes the size of a data block subject to steaming for the PMEM to local memory copy (step S410).

Then, the I/O processor 30 computes PMEM start and end addresses of the data packet existing in the PMEM (step S420), and finds start and end addresses of the data packet existing in the local memory (step S430). Then, the I/O processor confirms whether the PCI bus 70 is in use, and if the DMA controller does not perform any other work (step S440), the I/O processor send a PMEM to local memory copy transmission command to the DMA part (step S450).

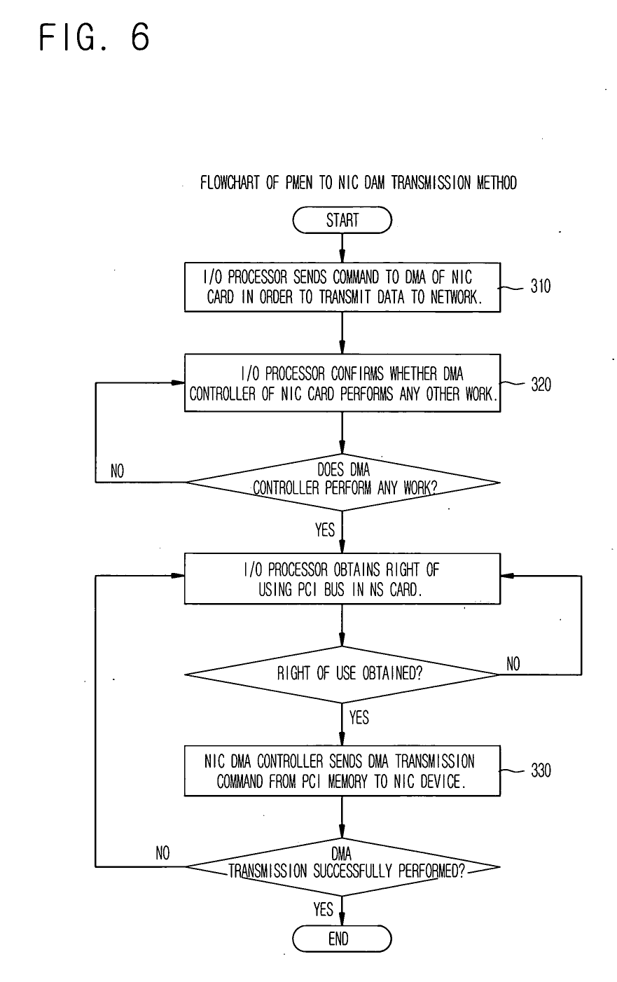

FIG. 6 is a flowchart illustrating a PMEM to NIC DMA transmission method according to the present invention.

According to the PMEM to NIC DMA transmission method as illustrated in FIG. 6, the I/O processor 30 sends a command for transmitting the data to the network to the DMA part of the NIC card 10 (step S500).

The NIC card 10 confirms whether the DMA controller performs any other work (step S510), and if the DMA controller does not perform any other work, it obtains the right of using the PCI bus 70 provided in the NS card 10 (step S520).

Then, the NIC card 10 computes the checksum value that includes a scatter/gather and headers (i.e., IP, TCP header and UDP header) instead of the CPU so that the NIC 50 can access the headers through the DMA method even if the headers are not successively arranged in memory addresses but are apart from one another with respect to the start address of the streaming data to be transmitted to the network. As a result, the NIC 50 performs the checksum offloading that does not require the CPU function during a zero-copy transmission, so that the data headers stored in the PMEM are transmitted to the NIC 50 through the PCI memory 60 (step S530).

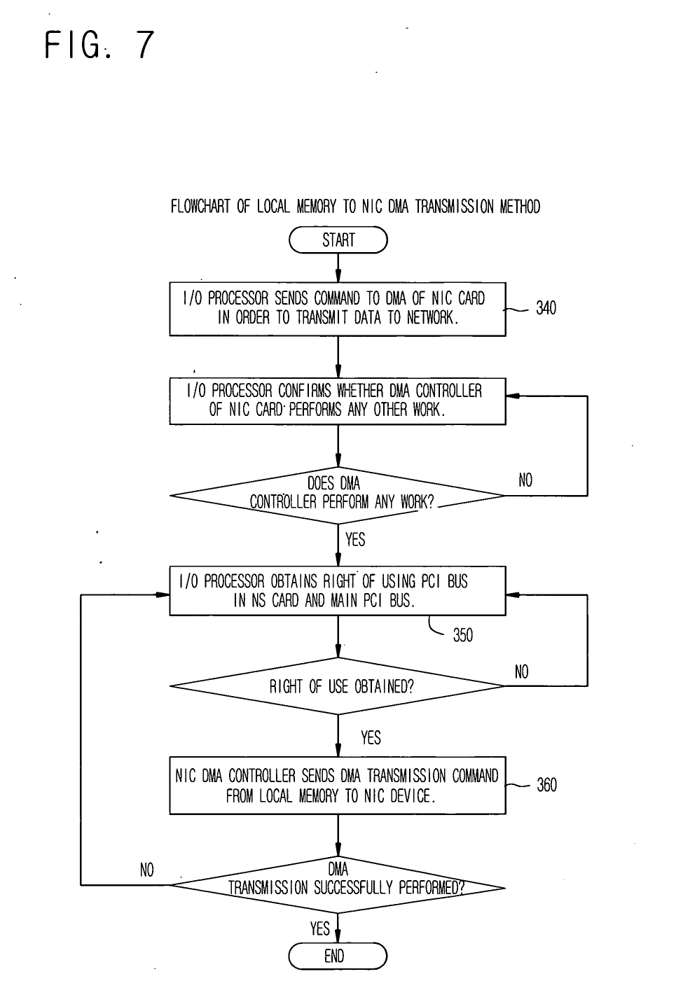

FIG. 7 is a flowchart illustrating a local memory to NIC DMA transmission method according to the present invention.

As illustrated in FIG. 7, the I/O processor 30 sends a command for transmitting the data to the network to the DMA part of the NIC card 50 (step S600).

The NIC card 50 then confirms whether the DMA controller performs any other work (step S610), and if the DMA controller does not perform any other work, it obtains the right of using the PCI bus 70 provided in the NS card 10 and the main PCI bus 5 (step S620). Then, the NIC card reads the data packet in the local memory through the DMA method and performs the checksum.

Then, the NIC card 50 sends a DMA transmission command from the local memory to the NIC device (step S630).

Accordingly, the network transmission and the synchronization of storage reading can be solved, so that the data transmission speed can be improved.

The apparatus and method for a high-speed streaming data transmission using a PMEM controller according to the present invention as described above can be implemented by a computer program and stored in a computer-readable recording medium (such as a hard disc, floppy disc, optomagnetic disc, CD ROM, ROM, RAM, etc.).

As described above, according to the present invention, the I/O processor that has received a command from the main processor transmits data stored in the storage device to the network through the process for the PMEM to PMEM copy of the data in the PM or for the PMEM to local copy of the data between the PM and the main memory. Specifically, the SCSI controller reads the data from the disc and stores the read data in the PM attached to the I/O processor, and the NIC reads the data from the PM and transmits the data by the zero-copy transmission method. Accordingly, in the network storage devices, the NIC and the SCSI device perform the data transmission using a large-capacity memory provided in the PCI bus segment that is equal to the corresponding device, not using the local memory of the host, so that the data transmission speed can be improved and the memory copy of the streaming data in the disc can be reduced.

Additionally, the present invention can minimize the interference with the main processor, and thus can support the QoS (Quality of Service) of the high-quality streaming data.

While the present invention has been described and illustrated herein with reference to the preferred embodiment thereof, it will be understood by those skilled in the art that various changes and modifications may be made to the invention without departing from the spirit and scope of the invention, which is defined in the appended claims.

1. An apparatus for a high-speed streaming data transmission using a PMEM (Processor Memory) controller, the apparatus comprising:
a PCI (Peripheral Component Interface) bus bridge, having a register installed therein for designating an address, for transferring a transferred bus transaction to a local PCI bus if the bus transaction requested by a main controller accesses NSUs (Network Storage Units);
an internal local PCI bus, separated from a main PCI bus outside the NSUs, for a date transmission with respective devices inside the NSUs;
a disc controller, connected in parallel to a plurality of disc storages connected to the NSUs, for managing data by dividing the data transferred to discs through the main processor or a network into specified data groups and storing the data groups in the discs;
a PM (Peripheral Memory), inherently provided inside the NSUs, for buffering a data transmission between the storages and the network; and
the PMEM controller for controlling a built-in register for designating a size of the PM, receiving a command of the main controller and making an SCSI (Small Component Small Interface) controller read from the discs and store in the PM the data to be transmitted to the network through a data block copy in the PM or a data block copy between the PM and a main memory, and making an NIC (Network Interface Controller) read the data from the PM and transmit the data through a DMA (Direct Memory Access) method.

2. A method of a high-speed streaming data transmission using a PMEM (Processor Memory) controller, the method comprising the steps of
(a) receiving a command from a main controller and obtaining a virtual address of a corresponding PCI (Peripheral Component Interface) memory area by mapping a specified area of a PMEM onto a user memory are, and then requesting an SCSI (Small Component Small Interface) disc block read to the PMEM area;
(b) an SCSI to PMEM copy step of storing the data of the corresponding disc block read by an SCSI controller in the corresponding PMEM area through a DMA (Direct Memory Access) method;
(c) sending a command to a DMA part of an NIC (Network Interface Controller) in order to transmit the data stored in the PMEM area to a network; and
(d) the DMA part of the NIC transmitting the read data to the network by performing a checksum offloading of the data after confirming works of a PCI bus and a main PCI bus.

3. The method as claimed in claim 2, wherein the step (b) comprises the step of (e) computing a size of a data block subject to streaming according to the command from the main controller, finding start and end addresses of a data packet existing in the PMEM area, and performing a PMEM to PMEM copy of the data through a DMA controller.

4. The method as claimed in claim 2, wherein the step (b) comprises the step of (f) finding a size of a data block subject to streaming and start and end addresses of a data packet existing in the PMEM area according to the command from the main controller, finding start and end addresses of a data packet existing in a local memory, and then performing a PMEM to local copy of the data through a DMA controller.

5. The method as claimed in claim 2, wherein the step (d) transmits a data block stored in the PMEM through the step (e) by performing a checksum offloading and scatter/gather of a start address of the streaming data to be transmitted to the network.

6. The method as claimed in claim 2, wherein the step (d) reads a data block stored in a PM (Peripheral Memory) and a main memory by the DMA method through the step (f), performs a checksum of the streaming data, and transmits the streaming data to the network.
